(19) United States
(12) Patent Application Publication
(10) Pub. No.: US 2012/0102513 A1
(43) Pub. Date: Apr. 26, 2012

(54) METHOD FOR MEASURING AUDIENCE DATA, CORRESPONDING TOKEN AND TERMINAL

(75) Inventors: Christophe Franchi, Auriol (FR); Laurent Jusseau, Aubagne (FR); Ali Zeamari, Marseille (FR)

(73) Assignee: GEMALTO SA, Meudon (FR)

(21) Appl. No.: 13/262,877

(22) PCT Filed: Apr. 1, 2010
(86) PCT No.: PCT/EP2010/054450

§ 371 Date: Jan. 10, 2012

(30) Foreign Application Priority Data
Apr. 6, 2009 (EP) 09305286.8

(51) Int. Cl. H04N 21/24

(52) U.S. Cl. 725/14

(57) ABSTRACT

The invention relates to a method for measuring audience data. The data is broadcast and received by at least one terminal. The data is relative to at least one channel included within the broadcast data. According to the invention, the terminal determines at least one piece of configuration data relating to at least one channel consumed by a terminal user, the at least one piece of configuration data comprising a first time difference between two time references, a first time reference relating to an exit from a channel and a second time reference relating to an access to the channel. The invention relates also to corresponding terminal and token.

### FIELD OF THE INVENTION

The invention relates, in a general manner, to a method for measuring audience data.

Moreover, the invention relates to a terminal for measuring audience data.

Finally, the invention relates to a token for measuring audience data.

Within the present description, a token is a portable smart object that is intended to communicate with the outside world. In particular, the token may cooperate with a terminal, as host device.

The present invention is notably applicable within a mobile TV (acronym for television) field, wherein a smart card or the like, as token, is coupled with a mobile telephone, as terminal.

### STATE OF THE ART

As known per se, notably within a standard termed OMA BOAST (acronym for “Open Mobile Alliance— BroadCAST”), a data broadcasting device, such as a server, broadcasts content data that is intended to a fleet of terminals. The content data is relative to at least one channel, such as one TV channel(s).

There is a need to provide a solution that allows to measure audience data that is efficient.

### SUMMARY OF THE INVENTION

The invention proposes a solution for satisfying the just hereinabove specified need by providing a method for measuring audience data. The data is broadcast and received by at least one terminal. The data is relative to at least one channel included within the broadcast data.

According to the invention, the terminal determines at least one piece of configuration data relating to at least one channel consumed by a terminal user; the at least one piece of configuration data comprising a first time difference between two time references, a first time reference relating to an exit from a channel and a second time reference relating to an access to the channel.

The principle of the invention consists in that the terminal is an active entity that processes data received and followed by a consumer by estimating at least one time period during which one or several channels are followed. The data resulting from the processing is the configuration data.

The concerned terminal user is the consumer of data that is(are) broadcast within a broadcast data stream. Each consumer or following person may benefit from the broadcast content(s), through at least one of the user senses, such as the eyesight, the hearing, the touch, the smell and/or the taste, and/or through a terminal data processing, like a data downloading, a data storing and/or an execution of a particular application (or service).

The configuration data, including the estimated time period during which one channel(s) is followed by the terminal user, is precise, determined at the terminal side, represented with few data and therefore efficient.

A configuration data amount is less than an amount of rough data relating to the audience measurement that takes into account two time references instead of a time difference for an estimation of a time period during which one channel is consumed by a terminal user.

Accordingly, the invention solution allows to save an amount of audience measurement data that is reduced with respect to the corresponding amount of rough historical data.

It is to be noted that the configuration data may be stored within or accessible from the terminal and is intended to represent, at least in part, the measured audience data, as audience measurement data.

The measured audience data may be reported to an outer entity, such as an audience measurement collecting server that collects all the audience measurements originating from the terminals that belong to consumers.

Accordingly, the invention solution allows to save time that is reduced by transmitting the configuration data with audience measurement data with respect to the corresponding time needed for transmitting the audience measurement data without the resulting configuration data. Therefore, the outer entity that may be addressed has to know how to interpret the configuration data. Furthermore, due to the terminal processing for at least the estimation of the time period(s) of the consumed channel(s), the outer entity is less involved for the processing with the received audience measurement data to exploit it.

According to a further aspect, the invention is a terminal for measuring audience data. The data is broadcast from outside and received by the terminal. The data is relative to at least one channel included within the broadcast data.

According to the invention, the terminal is adapted to determine at least one piece of configuration data relating to at least one channel consumed by a terminal user the at least one piece of configuration data comprising a first time difference between two time references, a first time reference relating to an exit from a channel and a second time reference relating to an access to the channel.

As terminal, it can be, for example, a Personal Digital Assistant (or PDA), a Personal Computer (or PC), a mobile laptop, or a portable TV. The terminal may be able to cooperate with a token.

According to a still further aspect, the invention is a token for measuring audience data. The token is intended to cooperate with a terminal. The data is broadcast from outside and received by the terminal. The data is relative to at least one channel included within the broadcast data.

According to the invention, the token is adapted to determine at least one piece of configuration data relating to at least one channel consumed by a terminal user, the at least one piece of configuration data comprising a first time difference between two time references, a first time reference relating to an exit from a channel and a second time reference relating to an access to the channel.

As token, it can be any electronic device comprising at least one microprocessor, as data processing means, at least one memory (or being connected to at least one memory), and an Input/Output communication interface. The token can constitute any electronic support, as a Secure Removable Module (or SRM). For example, it can be embodied within a smart dongle of the Universal Serial Bus (or USB) type (that does not require any specific reader within a host computer), a Secure Digital card (or SD card), a Multi-Media Card (or MMC) or a chip to be fixed to a terminal, preferably in a removable manner. The token is any electronic medium that may have different form factors.

The use of the invention token, as a processor of data relating to audience measurement data, is an efficient solution to process and preferably store data, termed configuration data, relating to the audience measurement data.

Such a solution allows to lighten, in terms of data processing, a terminal with which the token is coupled, as well as an audience measurement collecting device that collects the different configuration data originating from a plurality of tokens.

### BRIEF DESCRIPTION OF THE DRAWINGS

Additional features and advantages of the invention will be more clearly understandable after reading a detailed description of one preferred embodiment of the invention, given as an indicative and non-limitative example, in conjunction with the following drawings:

FIG. 1 illustrates a simplified diagram of one embodiment of a communication assembly, as terminal, comprising a mobile telephone and a SIM type smart card, as token, the communication assembly receiving broadcast data and being adapted to process data relating to channel(s) consumed by a terminal user and generate a reduced quantity of data, as configuration data, relating to the measured audience data; and

FIG. 2 represents an example of one scenario of consumed channels by a user of the communication assembly of FIG. 1.

### DETAILED DESCRIPTION

Herein under is considered a case in which the invention method for measuring audience data is implemented by a terminal, as a communication assembly, that includes a mobile telephone and a SIM type smart card, as token, coupled with the mobile telephone.

For example, instead of being constituted by a SIM type smart card, the token can be constituted by a dangle (that does not need any specific reader within a host computer), a USB smart card, and/or any other electronic medium that may have different form factors. According to still other examples, the token can also be a chip fixed, possibly in a removable manner, to a host device, or an embedded Secure Element, as a chip to be soldered within a host device.

Likewise, instead of being constituted by a mobile telephone, the terminal can be constituted, for example, by a set-up box, a Personal Computer (or PC), a desktop computer, a laptop computer, a media-player, a game console, a handset and/or a PDA.

Naturally, the herein below described embodiment is only for exemplifying purposes and is not considered to reduce the scope of the present invention.

According to another embodiment (not represented), a terminal, as a standalone entity, implements, on its own, the invention method, i.e. without any interaction with a token, so as to generate configuration data relating to channel(s) consumed by its user.

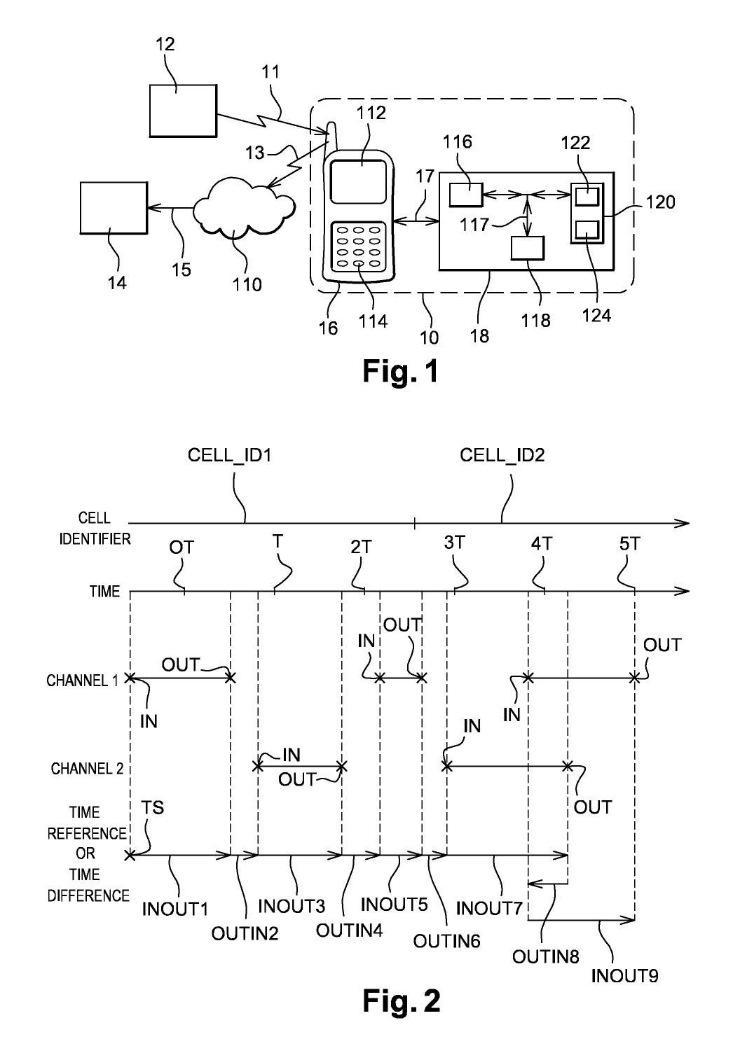

FIG. 1 schematically shows a communication assembly 10 that is or to be connected to, on the one hand, a broadcast server 12, and, on the other hand, an audience measurement collecting server 14.

For the sake of clarity and conciseness, the audience measurement collecting server 14 is termed herein below the collecting server 14.

The communication assembly 10, as terminal and mobile equipment, includes a mobile telephone 16 and a SIM type smart card 18, as token.

For the sake of simplicity, the mobile telephone 16 and the SIM type smart card 18 are termed hereinafter the phone 16 and the card 18 respectively.

According to another embodiment, instead of being a mobile communication assembly, the communication assembly is a stationary communication assembly, such as a PC.

The broadcast server 12, as data broadcasting device, is comprised within the OMA BCAST network, as broadcast network (not represented).

As broadcast network(s), it can be, for example, a Digital Video Broadcasting-Handheld network (or DVB-H); a Digital Audio Broadcasting network (or DAB); a Digital Multimedia Broadcasting network (or DMB); a Digital Radio Mondiale network (or DRM); a Multimedia Broadcast Multicast Services network (or MBMS); a BroadCast MultiCast Services network (or BCMCS); a Forward Link-Only network (or FLO); a Wimax network; a third generation network; and/or a fourth generation network.

The broadcast server 12 transmits, through a one-way communication link or downlink 11, data including content data (among others) to a plurality of terminals.

The content data is broadcast to the plurality of terminals (only one terminal 10 being represented) without identifying any particular addressee.

As content data, it can constitute data relating to at least one application, audio and/or video. The content data may be encrypted.

It is assumed that the phone user selects, for example, via a selection menu displayed on the phone display 112 with the help of a phone keyboard 114, a plurality of TV channels that is broadcast within the broadcast data. The TV channels that are contained within the content data are preferably encrypted, and, for instance, successively consumed by the phone user.

Information relating to configuration data that relates to audience measurement data is to be transmitted, through one or several messages, as an audience measurement report, from the phone 16 (among others) to the collecting server 14.

The information relating to configuration data is issued by the card 18, as is infra explained.

The collecting server 14 is a device that is intended to collect information relating to configuration data from a fleet of terminals, such as phones, that consume at least some of the broadcast data.

The collecting server 14 is adapted to process and interpret the configuration data, as audience measurement data. To decode the configuration data, the collecting server 14 knows encoding rules of data relating to audience measurement data, as configuration data.

Such encoding rules, that are infra explicated, are implemented by the card 18.

The collecting server 14 is connected to a mobile radio-communication network 110, through at least one mono-directional link 15, i.e. at least an uplink 15 through which the information relating to the configuration data is to be received.

The mobile radio-communication network 110 may be connected, through a long range radiofrequency at least mono-directional link or uplink 13, to the phone 16.

The phone 16 is one of the entities that receives the broadcast data.

The phone 16 is also one of the entities that will transmit, through a return channel, notably configuration data relating to audience measurement data.

The return channel connects the card 18, as the data processing and preferably storing device, through the phone 16, the uplink 13, the mobile radio-communication network 110, and the uplink 15, to the collecting server 14, as an audience report collecting device.

The return channel can include at least one of the following:
an Over-The-Air (or OTA) channel. As known per se, the OTA channel, such as a Short Message Service (or SMS) channel or a packet data channel as Bearer Independent Protocol (or BIP), is a channel that is generally used by the mobile radio-communication network 110 for remote card management features;
a Global System for Mobile communication (or GSM) channel;
a SMS channel;
an Internet Protocol (or IP) channel;
a General Packet Radio Service (or GPRS) channel;
an Enhanced Data rates for GSM Evolution channel;
a third Generation Partnership Project (or 3GPP) channel; and
a fourth radio-communication Generation channel.

As known per se, the phone 16 includes, as data processing means, at least one microprocessor, volatile and non-volatile memories, at least two Input/Output (or I/O) interfaces linked together through a data and control bus (not shown).

The I/O interfaces comprise a physical contact interface (not represented) of the type ISO (acronym for <<International Standard Organization>>) 7816, as one I/O interface, to interact with the card 18. The physical contact interface is intended to let communicate, through a bi-directional link 17, the phone 16 with the card 18.

According to another embodiment, instead of being a physical contact interface; the I/O interface with the card 18 is a contact-less interface, i.e. through a short range radiofrequency link.

The I/O interfaces comprise an antenna for receiving data broadcast OTA, via a long range radiofrequency (at least mono-directional) link 11, from the broadcast server 12.

The I/O interfaces comprise an antenna for sending, via the long range radiofrequency mono-directional link 13, through the mobile radio-communication network 110, the configuration data accompanied with the audience measurement data to the collecting server 14.

The phone microprocessor processes and controls data within the phone 16 and/or data to be exchanged with outside of the phone 16. The microprocessor controls and communicates with all the components of the phone 16, such as the I/O interfaces.

The phone memories store data notably relating to an Operating System and applications supported by the phone 16.

The phone 16 translates or renders, possibly thanks to data, like data relating to keys originating from the card 18 (that securely store them), the content data to provide a service to an end user. As provided service, for example, the phone 16 is able to make the content data (received from the broadcast server 12) perceptible to a phone user, as end user, notably through at least one phone interface, like a phone loudspeaker (not represented) and/or a phone display 112, for audio and/or video data.

The phone user is the owner of the phone 16.

The phone 16 allows the phone user, as consumer, to consume data, through one or several TV channels, that is broadcast from the broadcast server 12.

The names of the entities or the messages exchanged between the entities that are used within the present description are defined either by the OMA BOAST standard or by a mobile radio-communication network standard, such as a GSM, UMTS (acronym for “Universal Mobile Telecommunication System”) and/or CDMA (acronym for Code Division Multiple Access) network(s).

In the described preferred embodiment, the phone 16 accommodates the card 18. The card 18 may be removed from the phone 16. The card 18 is coupled to the phone 16, in order to cooperate with the phone 16.

According to another embodiment (not represented), the phone 16, as terminal, is one and the same entity for ensuring, besides the role of broadcast data receiver, the role of the invention card 18, as device for processing, generating and preferably storing the configuration data relating to audience measurement data. The role of the invention card 18 is infra explained.

The phone user also owns the card 18.

The card 18 is connected, through the bi-directional physical contact link 17, to the phone 16.

Alternately, instead of a physical contact link, the bi-directional link is a contact-less link like a short range radiofrequency link.

The card 18 may be notably solicited by the phone 16, so as to decrypt the encrypted content data, in order that the phone user be able to consume the content data in a clear manner, i.e. non-encrypted.

The card 18 is involved, as a processing and preferably storing device, so as to generate, store, and issue configuration data relating to audience measurement data.

To do this, the card 18 parses the consumed broadcast data, deduces audience measurement data, encodes the audience measurement data to generate the configuration data on a basis of the consumed broadcast data.

The configuration data represents data relating to audience measurement data in a compressed way with respect to the audience measurement data.

The configuration data to be transmitted originates from a memory space included within or being accessible from the card 18.

The configuration data preferably precedes values relating to some audience measurement data itself.

The issued configuration data is data in a reduced amount so as to be aware of the TV channel(s) followed by the terminal user with some details. The thus issued configuration data does not therefore require notably to store and send a large amount of data relating to one TV channel(s) consumed by a terminal user.

As card 18, it can be a smart card that securely stores an International Mobile Subscriber Identity (or IMSI), as a unique number associated with all GSM and UMTS network mobile phone users. The IMSI is used to identify a subscriber in relation with at least one mobile radio-communication network 110.

The card 18 can be, for example, a SIM smart card for a GSM network, a Universal Subscriber Identity Module (or USIM) for a UMTS network, a Removable User Identity Module (or RUIM), a CDMA Subscriber Identity module (or CSIM) for a CDMA network, and/or an Internet Protocol multimedia Services Identity Module (or ISIM) for IP Multimedia Subsystem or IMS). Naturally, the just aforementioned list is not exhaustive but only for exemplifying purposes and is not considered to reduce the scope of the present invention.

The card 18 includes a chip.

The chip includes, as data processing means, at least one card microprocessor 116, volatile and non-volatile card memories 120, at least one card I/O interface 118 linked together through a data and control bus 117.

The card I/O interfaces 118 comprise one contact interface (not represented) of the type ISO 7816, to interact with the phone 16. The contact interface is intended to let communicate, through the bi-directional link 17, the card 18 with the phone 16.

To exchange data, the phone 16 and the card 18 may use Application Protocol Data Unit (or APDU) or HyperText Transfer Protocol (or HTTP) through the bi-directional link 17.

The card microprocessor 116 processes and controls data within the chip and/or data to be exchanged with outside of the chip. The card microprocessor 116 controls and communicates with all the components of the chip, such as the card I/O interface 118.

The card memories 120 store data notably relating to an Operating System and applications supported by the chip.

The card memories 120 can be constituted by one or several EEPROM (acronym for “Electrically Erasable Programmable Read-Only Memory”), one or several ROM (acronym for “Read Only Memory”), one or several Flash memories, and/or any other memories of different types, like one or several RAM (acronym for “Random Access Memory”).

The card memories 120 may store at least one credential, such as one decryption key, so as to access to the broadcast data that is transmitted to the phone 16, as an external entity.

The credential(s) may be used to decrypt data, authenticate the broadcast server 12 before any external entity, like the card 18, and/or sign data to be sent to the outside world, like the collecting server 14, possibly by using data that is received from outside.

The card memories 120 may store a Universal Resource Locator (or URL) in ASCII format or IP address with a corresponding port number relating to the collecting server 14, to be used for a transfer of the configuration data to its destination.

According to a preferred embodiment of the invention, the card 18 is arranged so as to determine configuration data relating to the TV channel(s) that is(are) consumed by the phone user, and store the configuration data, as audience measurement data.

To do this, the card memories 120 include a memory space 122 that records an application for measuring audience data.

The application for measuring audience data is to be used to track the phone user consumption of broadcast data.

The application for measuring audience data is preferably in a Java language.

When executed by the card microprocessor 116, the application for measuring audience data notably allows to yield configuration data relating to one or several TV channels consumed by the phone user. Such an execution by the card microprocessor 116 is preferably transparent to the phone user when a change of a TV channel is carried out, i.e. the phone user is not informed about a simultaneous processing of data relating to the consumed TV channel(s).

The thus yield configuration data results from encoding rules that are to be known from each entity that has to interpret it, such as the collecting server 14.

The card memories 120 preferably contain another memory space 124 that records data including configuration data, as result of the execution by the card microprocessor 116 of the application for measuring audience data.

According to a first alternative, instead of the card 18, the phone 16 includes a memory space that records the result of the data yield by the application for measuring audience data.

According to a second alternative, instead of the card 18, the phone 16 accesses another memory space, such as a memory incorporated within another card (not represented), as another token connected to the phone 16, that records the result of the data yield by the card microprocessor 116 when executing the application for measuring audience data. The card 18 may access, through the phone 16, to the other memory space, so as to store the resulting configuration data (yield by the executed application for measuring audience data).

The memory space 124 is preferably a buffer that is for example a First In First Out (or FIFO) buffer. The buffer may have a size comprised between 100 bytes and one or some kilobytes. The memory space 124 recording the configuration data may be empty either when a predefined trigger size value is reached or when a timer has reached a predefined time period. The transfer of the configuration data may be at an initiative of the card 18 or from an external entity, like the collecting server 14 (when a downlink (not represented) is available).

The configuration data preferably is data that is encoded in a format that removes, as far as possible, redundancy without any loss of useful information.

The configuration data advantageously occupies a reduced memory space with respect to historical data relating to the broadcast data followed by the phone user.

The configuration data may include one or several different data fields as the audience data that the card 18 measures.

The configuration data may notably include data relating to at least one time reference, as one data field.

The time reference is for example a time stamp within the TV domain. The data relating to the time stamp is represented and stored on 4 bytes.

The card 18 retrieves the time stamp from a broadcast message that vehicles a Short Term Key, known as the Short Term Key Message (or STKM).

The card 18 may retrieve a time reference pertaining to an access to a TV channel by referring to a corresponding first received STKM.

The card 18 may retrieve a time reference pertaining to an exit from a TV channel by referring to a corresponding last received STKM.

The time reference may be a counter value or a machine time.

The time reference may be specific to a given channel consumed by the phone user.

Preferably, the time reference is incremented with a progress of the time, so as to ensure an anti-replay protection, i.e. to avoid to consume a TV channel once again without having the corresponding rights, namely the decryption key to be used to decrypt the encrypted broadcast data.

The configuration data may notably include data relating to at least a first time difference between two time references, as one data field.

The first time difference consists of an arithmetic difference of a time reference relating to an exit from a TV channel and a time reference relating to an access to the channel. The access and the exit respectively coincide with a beginning and an end of the consumption of the concerned TV channel for one and the same session. In other words, the arithmetic difference corresponds to the time reference when exiting a TV channel minus the time reference when entering the considered TV channel.

The configuration data relating to the first time difference is always null or positive since, according to OMA BCAST specifications, the time reference is incremented with a time progress.

In the event that the first time difference is null, i.e. when the exiting time reference and the access time reference are identical for a quick zapping, namely less than a cryptographic time period, the configuration data relating to the first time difference is only represented and stored on one bit (instead of one byte).

The cryptographic time period may be around thirty seconds.

In the event that the first time difference is strictly positive, the configuration data relating to the first time difference is represented and stored on one to four bytes.

The configuration data may notably include data relating to at least a second time difference between two time references pertaining to two channels, as one data field, one time reference being relative to an access to a channel and another time reference being relative to an exit from an immediately previous channel.

A time reference may be dependent on a channel, and another time reference may be dependent on another channel. The time references may be independent of each other, and therefore not synchronized.

The second time difference between two time references consists of an arithmetic difference of a time reference relating to an access to a channel and a time reference relating to an exit from a just preceding channel.

The configuration data relating to the second time difference is negative or positive.

The configuration data relating to the second time difference may be represented, firstly by a sign relating to the arithmetic difference, and then, an absolute value of the arithmetic difference itself. The sign relating to the arithmetic difference is represented and stored on one bit. The absolute value relating to the arithmetic difference is represented and stored on one to four bytes.

The second time difference represents, when its value is positive, a time period during which no TV channel is watched by the phone user, and, when its value is negative, a time period during which the two time references are not synchronized.

The configuration data may include a piece of information indicating a length of data relating to at least one time difference and/or data relating to a value of the at least one time difference.

The TV channel identifier identifies a TV channel consumed by the phone user.

The TV channel identifier may be represented by data relating to a key domain identifier and a key group part.

The card 18 may retrieve a key domain identifier and a key group part from a corresponding received STKM.

The key domain identifier represents a mobile country and network code and is represented on three bytes. When data field relating to the key domain identifier is not present, the key domain identifier that is to be considered is the corresponding previous occurrence stored within the memory space 124.

The configuration data relating to the TV channel identifier may include a piece of information indicating whether a key domain identifier is the same than or different from the one relating to a previous consumed TV channel.

The configuration data relating to the TV channel identifier is identical or different from the one of the just preceding consumed TV channel is represented and stored on one bit.

In the event that the key domain identifier is the one relating to a preceding consumed TV channel, the corresponding configuration data relating to the TV channel identifier may be equal to zero.

Otherwise, i.e. in the event that the key domain identifier changes with respect to the one relating to a preceding consumed TV channel, the corresponding configuration data relating to the TV channel identifier may be equal to one.

The configuration data relating to the TV channel identifier may include a piece of information indicating whether a first occurrence of a key group part relating to a TV consumed channel has already been stored or not for a previous consumed TV channel.

When applicable, i.e. when the first occurrence of the key group part exists, the configuration data includes data pertaining to a value relating to an index of such a first occurrence within a phone user zapping session and that has been previously stored within the memory space 124. The configuration data relating to the index of such a first occurrence of the TV channel identifier is represented and stored on one byte.

The configuration data may include a piece of information indicating whether at least one geographical location at which the phone 16 is situated is the same than or different from a previous occupied geographical location, and/or a piece of information indicating whether a first occurrence of the geographical location has been previously stored or not within the memory space 124.

When applicable, i.e. when the first occurrence of the geographical location exists, the configuration data includes data pertaining to a value relating to an index of such a first occurrence within a phone user zapping session and that has been previously stored within the memory space 124. The configuration data relating to the index of such a first occurrence of the geographical location is represented and stored on one byte.

The geographical location at which the phone 16 is situated may be a base station (or cell) identifier within a mobile radio-communication network 110 that is provided through the phone 16 by a network element, such as the Home Resource Locator (or HRL).

The geographical location at which the phone 16 is situated may be only tracked each time the phone 16 moves from an already registered previous geographical location to a new current geographical location.

The card 18 may retrieve a geographical location at which the phone 16 is situated through an event received from the phone 16.

The phone 16 informs the card 18 each time the phone 16 enters into a new base station and each time the phone 16 exits from a current base station that is therefore stored within the memory space 124.

Herein under is specified some examples of encoding data, as configuration data to be stored within the memory space 124 with a size of two bytes for a given consumed TV channel.

The different used types are the following ones: u1 as one unsigned byte, u2 as two unsigned bytes, u3 as three unsigned bites and u4 as four unsigned bytes.

When a key domain identifier is present, a sixteenth bit is set to “one”.

When a key domain identifier is absent, the sixteenth bit is set to “zero” and a corresponding key domain identifier to be considered is a previous key domain identifier occurrence within the memory space 124.

When a key group part is present, each of the six bits from a fifteenth bit to a tenth bit is set to “zero”.

When a key group part is absent, each of the six bits from the fifteenth bit to the tenth bit is set to a binary value that globally represents an index of a first occurrence of the key group part to be considered within the memory space 124.

When a second time difference has a null or positive value, a ninth bit is set to “zero”.

When a second time difference has a negative value, the ninth bit is set to “one”. The second time difference is negative when the time references pertaining to a channel and the previous channel are not synchronized.

When a second time difference is not present, each of an eighth bit to a sixth bit is set to “zero”. The second time difference is absent when the time reference is present within the corresponding configuration data or when the second time difference is null.

When a second time difference is present and its type value is defined by the three bits from the eight bit to the sixth bit, namely one (i.e. “001”) for u1, two (i.e. “010”)for u2, three (i.e. “011”) for u3 and four (i.e. “100”) for u4.

When a time reference is present, the three bits from the eight bit to the sixth bit are set to seven (i.e. “111”).

If a second time difference is present then no time reference is present within the corresponding configuration data.

When a geographical location status indicating that the phone user does not access a new base station is not present, the fifth bit is set to zero.

When a geographical location status indicating that the phone user accesses a new base station is present, the fifth bit is set to one.

When a first time difference is not present, i.e. has a null value, each of a fourth bit to a second bit is set to “zero”.

When a first time difference is present and its type value is defined by the three bits from the fourth bit to the second bit, namely one (i.e. “001”) for u1, two (i.e. “010”) for u2, three (i.e. “011”) for u3 and four (i.e. “100”) for u4.

When a geographical location status indicating that the phone user leaves a current base station is not present, the first bit is set to zero.

When a geographical location status indicating that the phone user leaves a current base station is present, the first bit is set to one.

The configuration data is followed by a value for each configuration data field to be specified.

One example of one scenario of two TV channels that are consumed by the phone user is schematically given by FIG. 2.

As depicted within the example of FIG. 2, the phone user changes five times from TV channels while taking into account one change for a first TV channel consumption.

Successive configuration data generated and stored by the card 18 for each change of a TV channel (or zapping) for a phone user zapping session is indicated herein below.

As a first zapping to “channel 1”, a first data chain of a two byte size, as configuration data, is as follows from a most significant bit to a least significant bit:

“1 000000 0 111 1 001 0” that specifies:
with the sixteenth bit set to one, as the most significant bit, that a key domain identifier is present and its value will follow at a first position within a list of the specified values;
with the next six bits set to zero, from the fifteenth to the tenth bit, that a key group part is present and its value will follow at a second position within the list of the specified values;
with the ninth bit set to zero accompanied with the eighth to the sixth bits set to one, that a second time difference is null or positive and not to be considered since a time stamp is present and placed at a third position within the list of the specified values;
with the fifth bit set to one, that an access into a base station of the phone user is present and placed at a fourth position within the list of the specified values;
with the second bit set to one while the fourth and the third bits being set to zero, that a first time difference is present and placed at a fifth position within the list of the specified values. It is to be noted that a first time difference is present and indicated only when its value equals to at least one cryptographic time period. This is the reason why the second time difference referenced “inout5” is not present within the stored data;
with the first bit set to zero, that no exit from a base station of the phone user is present.

The first data chain of a two byte size is followed by a value for each data field to be specified, for example in binary format, namely:
a value of a key domain identifier that may be represented by “key_domain_id” with three bytes;
a value of a key group part that may be represented by “key_group_part1” with two bytes, that allows to identify a value of a TV channel identifier with the value of the key domain identifier, as the first TV channel consumed by the phone user;
a value of a time stamp that may be represented by “ts” with four bytes, as a time reference at which the first TV channel is begun to be consumed;
a value of a location status that may be represented by “location_status_in1” with four bytes, as a geographical location at which the first TV channel is begun to be consumed;
a value of a first time difference that may be represented by “inout1” with one byte, as a time duration expressed in terms of cryptographic time period(s) during which the first TV channel is consumed.

As a second zapping to “channel 2”, a second data chain of a two byte size, as configuration data, is as follows from a most significant bit to a least significant bit:

“0 000000 0 000 0 001 0” that specifies:
with the sixteenth bit set to zero, as the most significant bit, that no key domain identifier is present and no value will follow. This means that the previous recorded key domain identifier is still valid;
with the next six bits set to zero, from the fifteenth to the tenth bit, that a key group part is present and its value will follow at a first position within a list of specified values;
with the ninth bit set to zero accompanied with the eighth to the sixth bits set to zero, that a second time difference is null or positive and that the second time difference is not present. It is to be noted that a second time difference is indicated only when its value equals to at least one cryptographic time period. This is the reason why the second time differences referenced outin2″ and “outin6” are therefore not present;
with the fifth bit set to zero, that no access into a base station of the phone user is present. This means that the previous access to the recorded base station of the phone user is still valid;
with the fourth and the third bits being set to zero and the second bit set to one, that a first time difference is present and of u1 type. Its value will follow at a second position within the list of specified values; and
with the first bit set to zero, that no exit from a base station of the phone user is present.

The second data chain of a two byte size is followed by a value for each data field to be specified, for example in binary format, namely:
a value of a key group part that may be represented by “key_group_part2” with two bytes, that allows to identify a value of a TV channel identifier with the previous value of the key domain identifier, as the second TV channel consumed by the phone user;
a value of a location status that may be represented by “location_status_in1” with four bytes, as a geographical location at which the first TV channel is begun to be consumed;
a value of a first time difference that may be represented by “inout3” with one byte, as a time duration expressed in terms of cryptographic time period(s) during which the second TV channel is consumed.

As a third zapping to “channel 1”, a third data chain of a two byte size, as configuration data, is as follows from a most significant bit to a least significant bit:

“0 000001 0 001 0 000 1” that specifies:
with the sixteenth bit set to zero, as the most significant bit, that no key domain identifier is present and no value will follow. This means that the previous key domain identifier is still valid;
with the next five bits set to zero, from the fifteenth to the eleventh bit, and the tenth bit set to one, that an index of the first occurrence of the concerned key group part is present and equals to one;
with the ninth to the seventh bits set to zero accompanied with the sixth bit set to one, that a second time difference is present and of u1 type. Its value will follow at a first position within a list of specified values;
with the fifth bit set to zero, that no access into a base station of the phone user is present. This means that the previous recorded access to the base station of the phone user is still valid;
with the fourth, the third, and the second bits being set to zero, that no first time difference is present; and
with the first bit set to one, that an exit from a base station of the phone user is present. Its value will follow at a second position within the list of specified values.

The third data chain of a two byte size is followed by a value for each data field to be specified, for example in binary format, namely:
a value of a second time difference that may be represented by “outin4” with one byte, as a time duration expressed in terms of cryptographic time period(s) before which a third TV channel is consumed by the phone user;
a value of a location status that may be represented by “location_status_out2” with four bytes, as a new geographical location that is occupied by the phone user.

As a fourth zapping to “channel 2”, a fourth data chain of a two byte size, as configuration data, is as follows from a most significant bit to a least significant bit:

“0 000010 0 000 0 001 0” that specifies:
with the sixteenth bit set to zero, as the most significant bit, that no key domain identifier is present and no value will follow. This means that the previous key domain identifier is still valid;
with the next four bits set to zero, namely from the fifteenth to the twelfth bit, the eleventh bit set to one and the tenth set to zero, that an index of the first occurrence of the concerned key group part is present and equals to two;
with the ninth to the sixth bits set to zero, that no second time difference is present;
with the fifth bit set to zero, that no access into a base station of the phone user is present. This means that the previous recorded access to the base station of the phone user is still valid;
with the fourth and the third bits being set to zero and the second bit set to one, that a first time difference is present and of u1 type. Its value will follow at a first position within a list of specified values; and
with the first bit set to zero, that an exit from a base station of the phone user is not present.

The fourth data chain of a two byte size is followed by a value for each data field to be specified, for example in binary format, namely a value of a first time difference that may be represented by “inout7” with one byte, as a time duration expressed in terms of cryptographic time period(s) during which a fourth TV channel is consumed by the phone user.

As a fifth zapping to “channel 1”, a fifth data chain of a two byte size, as configuration data, is as follows from a most significant bit to a least significant bit:

“0 000001 1 001 0 001 0” that specifies:
with the sixteenth bit set to zero, as the most significant bit, that no key domain identifier is present and no value will follow. This means that the previous key domain identifier is still valid;
with the next five bits set to zero, from the fifteenth to the eleventh bit, and the tenth bit set to one, that an index of the first occurrence of the concerned key group part is present and equals to one;
with the ninth bit set to one, that a second time difference is strictly negative. It is to be noted that this is a particular case in which the respective time references pertaining to the two concerned channels (namely the currently consumed channel and the previous consumed channel) are not synchronized since the second time difference is negative;
with the eighth and the seventh bits set to zero accompanied with the sixth bit set to one, that a second time difference is present and of u1 type. Its value will follow at a first position within a list of specified values;
with the fifth bit set to zero, that no access into a base station of the phone user is present. This means that the previous recorded access to the base station of the phone user is still valid;
with the fourth and the third bits being set to zero and the second bit set to one, that a first time difference is present and of u1 type. Its value will follow at a second position within the list of specified values; and
with the first bit set to zero, that an exit from a base station of the phone user is not present.

The fifth data chain of a two byte size is followed by a value for each data field to be specified, for example in binary format, namely:
a value of a second time difference that may be represented by “outin8” with one byte, as a time duration expressed in terms of cryptographic time period(s) before which a fifth TV channel is consumed by the phone user;
a value of a first time difference that may be represented by “inout9” with one byte, as a time duration expressed in terms of cryptographic time period(s) during which the fifth TV channel is consumed.

As result, compression rates for data relating to time information within corresponding configuration data with respect to the same data without being configured that is stored within the memory space 124 may be obtained.
In the worst case, one byte out of eight bytes (that is to say a compression rate of 12.5% ) corresponding to a case in which only one TV channel is consumed by a phone user. Corresponding configuration data comprises encoded data for one time reference represented on four bytes, a first time difference represented on two bytes and a value of the first time difference in terms of a count of a cryptographic time period(s) represented on one byte, instead of four bytes for a time reference relating to an access to a TV channel and other four bytes for another time reference relating to an exit from the TV channel.
In the best case, six bytes out of sixteen bytes (that is to say a compression rate of 37.5%) corresponding to a case in which only two successive TV channels are consumed by a phone user. Corresponding configuration data comprises encoded data for one time reference represented on four bytes, a first time difference represented on two bytes and a value of the first time difference in terms of a count of a cryptographic time period(s) represented on one byte and another first time difference represented on two bytes and a value of the first time difference in terms of a count of a cryptographic time period(s) represented on one byte, instead of four bytes for a time reference relating to an access to a first TV channel, other four bytes for another time reference relating to an exit from the first TV channel, a time reference relating to an access to a second TV channel and other four bytes for another time reference relating to an exit from the second TV channel.

1. A method for measuring audience data, data being broadcast and received by at least one terminal, the data being relative to at least two channels included within the broadcast data,
wherein the terminal determines at least one piece of audience measurement data relating to at least two channels consumed by a terminal user, the at least one piece of audience measurement data comprising at least one time difference between two time references, a first time reference relating to an access to a first channel and a second time reference relating to an exit from a second channel, the time difference being an arithmetic difference between the first time reference and the second time reference.

2. Method according to claim 1, wherein the terminal stores the at least one piece of audience measurement data.

3. Method according to claim 1, wherein the at least one piece of audience measurement data further comprises at least one element of the group comprising:
data relating to at least one time reference;
data relating to at least two channel identifiers relating to the at least two channels consumed by the terminal user;
data relating to at least one geographical location at which the terminal is situated.

4. Method according to claim 3, wherein the first channel and the second channel are two different channels, the first channel being consumed by the terminal user after the second channel.

5. Method according to claim 3, wherein the first time reference is dependent on the first channel and the second time reference is dependent on the second channel.

6. Method according to claim 5, wherein the first time reference and the second time reference are independent of each other.

7. Method according to claim 3, wherein the data relating to the time difference comprises at least one element of the group comprising:
a piece of information indicating whether the time difference is null or not null;
a piece of information indicating whether the time difference is positive or negative;
a piece of information indicating a length of the data relating to the time difference;
data relating to a value of the time difference;
wherein data relating to at least two channel identifiers comprises at least one element of the group comprising:
a piece of information indicating whether a key domain identifier is the same than or different from the one relating to a previous consumed channel;
a piece of information indicating whether a first occurrence of a key group part relating to a consumed channel has already been stored or not for a previous consumed channel; and/or
wherein data relating to at least one geographical location comprises at least one element of the group comprising:
a piece of information indicating whether a geographical location is the same than or different from a previous one;
a piece of information indicating whether a first occurrence of the geographical location has been previously stored or not.

8. Method according to claim 1, wherein the terminal sends the at least one piece of audience measurement data, through a return channel, to an audience measurement collecting device, the return channel including at least one element belonging to a group comprising:
an Over The Air channel;
a Global System for Mobile communications channel;
a Short Message Service channel;
an Internet Protocol channel;
a General Packet Radio Service channel;
a Enhanced Data rates for GSM Evolution channel;
a third generation channel;
a fourth generation channel.

9. A terminal for measuring audience data, data being broadcast from outside and received by the terminal, the data being relative to at least two channels included within the broadcast data,
wherein the terminal is adapted to determine at least one piece of audience measurement data relating to at least two channels consumed by a terminal user, the at least one piece of audience measurement data comprising at least one time difference (OUTIN2) between two time references, a first time reference relating to an access to a first channel and a second time reference relating to an exit from a second channel, the time difference being an arithmetic difference between the first time reference and the second time reference.

10. A token for measuring audience data, the token being intended to cooperate with a terminal, data being broadcast from outside and received by the terminal, the data being relative to at least two channels included within the broadcast data,
wherein the token is adapted to determine at least one piece of audience measurement data relating to at least two channels consumed by a terminal user, the at least one piece of audience measurement data comprising at least one time difference between two time references, a first time reference relating to an access to a first channel and a second time reference relating to an exit from a second channel, the time difference being an arithmetic difference between the first time reference and the second time reference.
